(19) United States
(12) Patent Application Publication
(10) Pub. No.: US 2020/0190246 A1
(43) Pub. Date: Jun. 18, 2020

(54) IMPACT-RESISTANT THERMOPLASTIC POLYURETHANES, PRODUCTION AND USE THEREOF

(71) Applicant: Covestro Deutschland AG, Leverkusen (DE)

(72) Inventors: Yi SHEN, Dormagen (DE); Peter REICHERT, Dormagen (DE)

(21) Appl. No.: 16/489,851

(22) PCT Filed: Feb. 28, 2018
(86) PCT No.: PCT/EP2018/054954

§ 371 Date: Oct. 23, 2019

(30) Foreign Application Priority Data
Mar. 2, 2017 (EP) 17158800.7

(51) Int. Cl. C08G 18/08; C08G 18/76; C08G 18/22; C08G 18/32; C08K 13/02; C08G 18/42; C08G 18/66; C08G 18/48

(52) U.S. Cl. CPC C08G 18/0895; C08G 18/7671; C08G 18/222; C08G 18/0838; C08G 18/4825; C08K 13/02; C08G 18/4238; C08G 18/664; C08G 18/3206

(57) ABSTRACT

The present invention relates to polyester-based hard thermoplastic polyurethane systems which are impact-resistant at low temperatures, and to the production and use thereof.

The present invention relates to polyester-based hard thermoplastic polyurethane systems which are impact resistant at low temperatures and to the production and use thereof.

Thermoplastic polyurethane elastomers (TPU) have long been known. They are of great industrial importance due to the combination of high-level mechanical properties with the known advantages of cost-effective thermoplastic processability. The use of different chemical building block components makes it possible to achieve great variation in mechanical properties. An overview of TPU, their properties and applications is described for example in Kunststoffe 68 (1978), pages 819 to 825, or Kautschuk, Gummi, Kunststoffe 35 (1982), pages 568 to 584. TPU can be prepared continuously or batchwise. The best-known industrial production processes are the belt process (GB 1057018 A) and the extruder process (DE 1964834 A and DE 2059570 A).

In a comparison of polyether-based TPU and polyester-based TPU, polyether-based TPU show better low-temperature flexibility while polyester-based TPU show better mechanical properties at room temperature. For many applications which are subjected to low temperatures only on a short-term basis, polyester-based TPU are therefore selected on account of their advantageous mechanical properties. An impact modifier is often added to improve low-temperature impact resistance. It is customary to employ polymers such as for example copolymers of acrylonitrile, butadiene and styrene (ABS) as an impact modifier. However, it is not easy from a technical perspective to achieve homogeneous incorporation of such a material into the TPU during production thereof.

The present invention accordingly has for its object to provide alternative impact modifiers which can be incorporated very homogeneously during TPU production and which ensure good low-temperature flexibility of the TPU without negatively affecting the other good mechanical properties.

It has now been found that, surprisingly, this object is achieved when polyether polyols having a high molecular weight are employed instead of the commercially available impact modifiers. These additionally have the advantage that they are incorporated during production of the TPU.

These polyether polyols make it possible both to improve the low-temperature flexibility of the TPU while simultaneously reducing the complexity of TPU production. The specific use of the polyether polyols as impact modifiers made it possible to improve the low-temperature impact resistance of the TPU and to render its production simple.

The invention accordingly provides thermoplastically processable polyurethane elastomers having a hardness of 56 to 85 Shore D (according to ISO 7619-1: 2012-02) obtainable from the reaction of the components

a) one or more substantially linear polyester polyols having a number-average functionality of 1.8 to 2.2 and a number-average molecular weight of 500 to 4000 g/mol based on dicarboxylic acids selected from the group consisting of adipic acid, succinic acid, terephthalic acid and derivatives thereof and based on dialcohols selected from the group consisting of ethanediol, 1,4-butanediol, 1,3-propanediol, 1,6-hexanediol and neopentyl glycol and optionally 0% to 60% by weight of polycarbonate diol based on 1,6-hexanediol,

b) one or more substantially linear polyether polyols having a number-average functionality of 1.9 to 2.1 and a number-average molecular weight of 4000 to 20 000 g/mol based on propylene oxide or propylene oxide/ethylene oxide mixtures,

c) one or more organic diisocyanate,

d) one or more diols having a number-average molecular weight of 60 to 250 g/mol as chain extenders,

in the presence of

e) optionally catalysts,

f) optionally auxiliary and/or additive substances,

g) optionally monofunctional chain terminators,

wherein the molar ratio of NCO groups to OH groups is from 0.9:1 to 1.1:1 and the weight ratio of the polyether polyols (b) to the polyester polyols (a) is from 5:95 to 30:70.

The thermoplastic polyurethanes according to the invention may be produced in the known one-shot process or prepolymer process.

Suitable polyester diols (a) may be produced for example from dicarboxylic acids having 2 to 12 carbon atoms, preferably 4 to 6 carbon atoms, and polyhydric alcohols. Examples of useful dicarboxylic acids include: aliphatic dicarboxylic acids such as succinic acid, glutaric acid, adipic acid, suberic acid, azelaic acid and sebacic acid, and aromatic dicarboxylic acids such as phthalic acid, isophthalic acid and terephthalic acid. The dicarboxylic acids may be used individually or as mixtures, for example in the form of a succinic, glutaric and adipic acid mixture. To produce the polyester polyols, it may in some cases be advantageous to employ not the dicarboxylic acids but rather the corresponding dicarboxylic acid derivatives such as carboxylic diesters having 1 to 4 carbon atoms in the alcohol radical, carboxylic anhydrides or carbonyl chlorides. Examples of polyhydric alcohols are glycols having 2 to 10 and preferably 2 to 6 carbon atoms, such as ethylene glycol, diethylene glycol, butane-1,4-diol, pentane-1,5-diol, hexane-1,6-diol, decane-1,10-diol, 2,2-dimethylpropane-1,3-diol, propane-1,3-diol and dipropytene glycol. Depending on the desired properties the polyhydric alcohols may be used alone or optionally in admixture with one another. Also suitable are esters of carbonic acid with the recited diols to form polycarbonate diols, in particular with those having 4 to 6 carbon atoms, such as 1,4-butanediol or 1,6-hexanediol, condensation products of hydroxycarboxylic acids, for example hydroxycaproic acid, and polymerization products of lactones, for example optionally substituted caprolactones. Preferably employed polyester polyols are ethanediol polyadipates, 1,4-butanediol polyadipates, 1,6-hexanediol polyadipates, ethanediol 1,4-butanediol polyadipates, 1,6-hexanediol neopentyl glycol polyadipates, 1,6-hexanediol 1,4-butanediol polyadipates and polycaprolactones. The polyester diols have molecular weights of 500 to 4000 g/mol, preferably 900 to 2500 g/mol, and may be used individually or in the form of mixtures with one another.

Suitable polyether polyols (h) may he produced by reacting an alkylene oxide having 2 and/or 3 carbon atoms in the alkylene radical with a starter molecule containing two active hydrogen atoms in bonded form. Alkylene oxides employed are ethylene oxide and propylene oxide, Contemplated starter molecules are for example: diols, such as ethylene glycol, 1,2-propylene glycol, 1,3-propylene glycol, 1,4-butanediol and 1,6-hexanediol. The substantially linear polyether polyols have molecular weights of 4000 to 20 000 g/mol, preferably 4000 to 12 000 g/mol, particularly preferably 4000 to 8500 g/mol. They may be used either individually or in the form of mixtures with one another.

Useful organic diisocyanates (c) include for example aliphatic, cycloaliphatic, araliphatic, heterocyclic and aromatic diisocyanates, such as are described in Justus Liebigs Annalen der Chemie, 562, p. 75-136.

Specific examples include for example: aliphatic diisocyanates, such as hexamethylene diisocyanate, cycloaliphatic diisocyanates, such as isophorone diisocyanate, 1,4-cyclohexane diisocyanate, 1-methyl-2,4-cyclohexane diisocyanate and 1-methyl-2,6-cyclohexane diisocyanate and also the corresponding isomer mixtures, 4,4′-dicyclohexylmethane diisocyanate, 2,4′-dicyclohexylmethane diisocyanate and 2,2′-dicyclohexylmethane diisocyanate and also the corresponding isomer mixtures, aromatic diisocyanates, such as 2,4-tolylene diisocyanate, mixtures of 2,4-tolylene diisocyanate and 2,6-tolylene diisocyanate, 4,4′-diphenylmethane diisocyanate, 2,4′-diphenylmethane diisocyanate and 2,2′-diphenylinethane diisocyanate, mixtures of 2,4′-diphenylmethane diisocyanate and 4,4′-diphenylinethane diisocyanate, urethane-modified liquid 4,4′-diphenyirnethane diisocyanates and 2,4′-diphenylmethane diisocyanates, 4,4′-diisocyanate-1,2-diphenylethane and 1,5-naphthylene diisocyanate. Preferably employed are 1,6-hexamethylene diisocyanate, isophorone diisocyanate, dicyclohexylmethane diisocyanate, diphenylmethane diisocyanate isomer mixtures having a 4,4′-diphenylmethane diisocyanate content of >96% by weight and especially 4,4′-diphenylmethane diisocyanate and 1,5-naphthylene diisocyanate. The recited diisocyanates may be employed singly or in the form of mixtures with one another. They may also be used together with up to 15% by weight (based on the total amount of diisocyanate) of a polyisocyanate, for example triphenylmethane 4,4′,4″-triisocyanate or polyphenylpolymethylene polyisocyanates.

Employed as chain extenders (d) are diols having a number-average molecular weight of 60 to 250 g/mol, preferably aliphatic diols having 2 to 14 carbon atoms, for example ethanediol, 1,6-hexanediol, diethylene glycol, dipropylene glycol and especially 1,4-butanediol. Also suitable however are diesters of terephthalic acid with glycols having 2 to 4 carbon atoms, for example ethylene glycol bisterephthalate or 1,4-butanediol bisterephthalate, hydroxyalkylene ethers of hydroquinone, for example 1,4-di(hydroxyethyl)hydroquinone and ethoxylated bisphenols. Mixtures of the abovernentioned chain extenders may also be employed. In addition, relatively small amounts of triols may also be added.

Employable catalysts (e) include the customary catalysts known from polyurethane chemistry. Suitable catalysts are customary tertiary amines known per se, for example triethylamine, dimethylcyclohexylamine, N-rnethylmorpholine, N,N′-dimethylpiperazine, 2-(dimethylaminoethoxy)ethanol, diazabicyclo[2.2.2]octane and the like and in particular organic metal compounds such as titanate esters, iron compounds, bismuth compounds, tin compounds, for example tin diacetate, tin diacetate, tin dilaurate or the dialkyltin salts of aliphatic carboxylic acids such as dibutyltin diacetate, dibutyltin dilaurate or the like. Preferred catalysts are organic metal compounds, in particular titanate esters, iron compounds or tin compounds. Dibutyltin dilaurate is very particularly preferred.

Employable auxiliary and additive substances (f) are for example lubricants, such as fatty acid esters, metal soaps thereof, fatty acid amides and silicone compounds, antiblocking agents, inhibitors, stabilizers against hydrolysis, light, heat and discoloration, flame retardants, dyes, pigments, inorganic or organic fillers and reinforcers. Reinforcers are especially fibrous reinforcing materials such as inorganic fibers which are produced according to the prior art and may also be sized. Further information about the recited auxiliary and additive substances may be found in the specialist literature, for example J. H. Saunders, K. C. Frisch: “High Polymers”, volume XVI, Polyurethane, part 1 and 2, Interscience Publishers 1962 and 1964, R. Gächter, H. Mülller (Ed.): Taschenhuch der Kunststoff-Additive, 3rd edition, Hanser Verlag, Munich 1989, or DE-A 29 01 774.

Also employable in small amounts to adjust TPU molecular weight are monofunctional chain terminators (g), for example monoalcohols (octanol and stearyl alcohol) or monoamines (butylamine and stearylamine). In some cases these also serve as demolding aids.

It is particularly preferable when the TPU are produced from the following principal components:

a) 1,4-butanediol polyadipates, 1,6-hexanediol polyadipates, ethanediol 1,4-butanediol polyadipates, 1,6-hexanediol neopentyl glycol polyadipates, 1,6-hexanediol 1,4-butanediol polyadipates and mixtures thereof

b) polypropylene oxides or polyethylene/polypropylene oxides having molecular weights of 4000 to 12 000 g/mol

c) 4,4′-diphenylmethane diisocyanate and/or hexamethylene diisocyanate

d) 1,4-butanediol, ethanediol and/or 1,6-hexanediol.

The invention further provides a process for continuous production of the thermoplastically processable polyurethane according to the invention, wherein the components (a), (b), (c) and (d) and optionally (e) to (g) are metered into a reaction extruder and while passing through the extruder react to afford the polyurethane.

The TPU according to the invention may be used for producing molded articles that are subjected to low temperatures (<0° C.), for example for producing ski shoes.

The invention further provides for the use of the polyether polyols (b) having a number-average functionality of 1.9 to 2.1 and a number-average molecular weight of 4000 to 20 000 g/mol based on propylene oxide or propylene oxide/ethylene oxide mixtures as a low-temperature impact modifier in the production of thermoplastically processable polyurethanes.

The invention shall be more particularly elucidated with reference to the examples which follow.

### EXAMPLES

### Raw Materials Employed

Tyzor® AA105: titanium catalyst from Dorf Ketal

Polyether® LP112: polypropylene glycol having a molecular weight of 1000 g/mol, commercially available product from Covestro AG

Irganox® 1010: antioxidant from BASF SE

Licowax® E: demolding agent from Clariant

Baysilone® M1000: silicone oil from Momentive

Stabaxol® I: hydrolysis stabilizer from Rheinchemie

### FM Formulation Example 1:

| | |
|---|---|
| Polybutanediol 1,4-adipate (molecular weight | 36.30% by weight |
| about 2250 g/mol): | |
| 1,4-Butanediol; | 14.62% by weight |
| 1,6-Hexanediol: | 0.91% by weight |
| 4,4′-Diphenylmethanediisocyanate (4,4′-MDI): | 46.57% by weight |
| 0.1% solution of Tyzor ® AA 105 in polyether | 0.15% by weight |
| LP112: | |
| Irganox ® 1010: | 0.24% by weight |
| Licowax ® E: | 0.30% by weight |
| Stearyl alcohol | 0.24% by weight |
| Baysilon ® M1000: | 0.02% by weight |
| Triphenylphosphine: | 0.47% by weight |
| Stabaxol ® I: | 0.18% by weight |

### Example 1 (Production of TPU 1)

36.30% by weight of polybutanediol 1,4-adipate (molecular weight about 2250 g/mol) were initially charged in a reaction vessel. 0.24% by weight of Irganox® 1010, 0.3% by weight of Licowax® E, 0.24% by weight of stearyl alcohol, 0.02% by weight of Baysilon® M1000 0.47% by weight of triphenylphosphine and 0.18% by weight of Stabaxol® I were dissolved therein. After heating to 180° C., 46.6% by weight of 4,4′-diphenylmethane diisocyanate (MDI) were added with stirring and the reaction was carried out using 10 ppm of Tyzor® AA105 (based on the polyol amount).

Once the reaction was complete 14.6% by weight of 1,4-butanediol and 0.9% by weight of 1,6-hexanediol were added with stirring and the NCO/OH ratio of all components was 1.0. The polymer melt was subjected to intensive mixing up to the maximum stirrable viscosity and then poured onto a tray. The polymer melt was subsequently heat-treated at 120° C. for 30 minutes.

### Production of TPU 2 to 11

Production was carried out analogously to example 1, but instead of polybutanediol 1,4-adipate the mixtures of polybutanediol 1,4-adipate and the corresponding amount in weight percent of polyether polyol reported in table 1 were employed.

### Measurements

Hardness was measured according to ISO7619-1: 2012-02 and tensile measurements were carried out according to ISO 53504: 2009-10.

### Charpy Impact Strength Testin

Charpy impact strength tests were carried out on injection molded test specimens according to DIN EN ISO179/1eA: 2010 at −20° C. The test specimen has dimensions of: 80±2 mm length, 10.0±0.2 mm breadth and 4.0±0.2 mm thickness. The test specimen is notched. The notch base radius r_{N} is 0.25±0.05 mm (see FIG. 1)

The measured properties of the examples are described in table I which follows:

TABLE 1
Composition and properties of the TPU of examples 1 to 11

| | | | 10% | 100% | Charpy Average value |
|---|---|---|---|---|---|
| | Amount of | | modulus | modulus | and type of break |
| Example | polyether polyal | Hardness | [MPa] | [MPa] | [KJ/m²] |
| 1 | 0% by weight | 64 Shore D | 16.60 | 27.70 | 4.99 s⁺⁾ |
| 2*⁾ | 10% by weight | 64 Shore D | 18.90 | 28.80 | 8.29 s⁺⁾ |
| | Acclaim ® 4200¹⁾ | | | | |
| 3*⁾ | 15% by weight | 64 Shore D | 20.10 | 28.90 | 10.76 s⁺⁾ |
| | Acclaim ® 4200¹⁾ | | | | |
| 4*⁾ | 20% by weight | 64 Shore D | 20.90 | 28.60 | 13.26 s⁺⁾ |
| | Acclaim ® 4200¹⁾ | | | | |
| 5*⁾ | 10% by weight | 64 Shore D | 19.0 | 29.40 | 5.98 s⁺⁾ |
| | Acclaim ® 8200²⁾ | | | | |
| 6*⁾ | 10% by weight | 64 ShoreD | 19.2 | 31.9 | 8.19 s⁺⁾ |
| | Acclaim ® 12200³⁾ | | | | |
| 7*⁾ | 10% by weight | 64 Shore D | 19 | 31.6 | 7.06 s⁺⁾ |
| | Acclaim ® 18200⁴⁾ | | | | |
| 8 | 10% by weight | 64 ShoreD | 16.5 | 29.6 | 4.4 s⁺⁾ |
| | Acclaim ® 2200⁵⁾ | | | | |
| 9 | 20% by weight | 64 ShoreD | 19.0 | 29.4 | 5.89 s⁺⁾ |
| | Acclaim ® 2200⁵⁾ | | | | |
| 10 | 10% by weight | 64 ShoreD | 16.7 | 29.5 | 6.49 s⁺⁾ |
| | Terathane ® 2000⁶⁾ | | | | |
| 11 | 10% by weight | 64 ShoreD | 15.7 | 28 | 7.16 s⁺⁾ |
| | Terathane ® 2900⁷⁾ | | | | |

*⁾Inventive example
¹⁾Acclaim ® 4200 is a linear polypropylene ether polyol (commercially available product from Covestro Deutschland AG, molecular weight about 4000)
²⁾Acclaim ® 8200 is a linear polypropylene ether polyol (commercially available product from Covestro Deutschland AG, molecular weight about 8000)
³⁾Acclaim ® 12200 is a linear polypropylene ether polyol (commercially available product from Covestro Deutschland AG, molecular weight about 12 000)
⁴⁾Acclaim ® 18200 is a linear polypropylene ether polyol (commercially available product from Covestro Deutschland AG, molecular weight about 18 000)
⁵⁾Acclaim ® 2200 is a linear polypropylene ether polyol (commercially available product from Covestro Deutschland AG, molecular weight about 2000)
⁶⁾Terathane ® 2000 is a linear polytetramethylene ether glycol (commercially available product from Invista, molecular weight about 2000)
⁷⁾Terathane ® 2900 is a linear polytetramethylene ether glycol (commercially available product from Invista, molecular weight about 2900)
⁺⁾type of break: s = brittle and z = tough

It is apparent that in the inventive examples containing polypropylene ether polyols having molecular weights of 4000 to 20 000 g/mol the Charpy values are considerably higher than in example 1 which contains no polyether polyol and in examples 8 to 11 which do not contain the polyether polyols according to the present invention. Accordingly the impact strength of the inventive TPU (examples 2 to 7) is better than that of the TPU from comparative examples 1 and 8 to 11.

1-10. (canceled)

11. A thermoplastically processable polyurethane elastomer (TPU) having a hardness of 56 to 85 Shore D (according to ISO 7619-1: 2012-02) obtained from the reaction of the components
a) one or more substantially linear polyester polyols having a number-average functionality of 1.8 to 2.2 and a number-average molecular weight of 500 to 4000 g/mol based on dicarboxylic acids selected from the group consisting of adipic acid, succinic acid, terephthalic acid and derivatives thereof, and based on dialcohols selected from the group consisting of ethanediol, 1,4-butanediol, 1,3-propanediol, 1,6-hexanediol and neopentyl glycol, and optionally 0% to 60% by weight of polycarbonate diol based on 1,6-hexanediol,
b) one or more substantially linear polyether polyols having a number-average functionality of 1.9 to 2.1 and a number-average molecular weight of 4000 to 20 000 g/mol based on propylene oxide or propylene oxide/ethylene oxide mixtures,
c) one or more linear organic diisocyanates,
d) one or more dials having a number-average molecular weight of 60 to 250 g/mol, in the presence of
e) optionally catalysts,
f) optionally auxiliary and/or additive substances,
g) optionally monofunctional chain terminators,
wherein the molar ratio of NCO groups to OH groups is from 0.9:1 to 1.1:1 and the weight ratio of the polyether polyols (b) to the polyester polyols (a) is from 5:95 to 30:70.

12. The thermoplastically processable polyurethane elastomer as claimed in claim 11, wherein the component (a) is a linear polyester polyol having a number-average molecular weight of 900 to 2500 g/mol and/or a polycarbonate diol having a number-average molecular weight of 1000 to 4000 g/mol.

15. The thermoplastically processable polyurethane elastomer as claimed in claim 11, wherein component (b) is a linear polyether polyol having a number-average molecular weight of 4000 to 12 000 g/mol, preferably of 4000 to 8500 g/mol.

14. The thermoplastically processable polyurethane elastomer as claimed in claim 11, wherein component (c) consists of one or more diisocyanates selected from the group consisting of 4,4′-diphenylmethane diisocyanate, 4,4′-dicyclohexylmethane diisocyanate and 1,6-hexamethylene diisocyanate.

15. The thermoplastically processable polyurethane elastomer as claimed in claim 11, wherein component (d) consists of one or more diols selected from the group consisting of 1,4-butanediol, 1,3-propanediol, 1,2-ethylene glycol, 1,6-hexanediol and hydroquinone monomethyl ether.

16. The thermoplastically processable polyurethane elastomer as claimed in claim 11, wherein component (a) is selected from one or more compounds from the group consisting of 1,4-butanediol polyadipates, 1,6-hexanediol polyadipates, ethanediol 1,4-butanediol polyadipates, 1,6-hexanediol neopentyl glycol polyadipates, 1,6-hexanediol 1,4-butanediol polyadipates, component (b) is selected from polypropylene oxides or polyethylene/polypropylene oxides having molecular weights of 4000 to 12 000 g/mol, component (c) is selected from 4,4′-diphenylmethane diisocyanate and/or hexamethylene diisocyanate and component (d) is selected from 1,4-butanediol, ethanediol and/or 1,6-hexanediol.

17. A process for continuous production of a thermoplastically processable polyurethane as claimed in claim 11, wherein components (a), (b), (c) and (d) and optionally (e) to (g) are metered into a reaction extruder and while passing through the extruder react to afford the polyurethane.

18. A method comprising utilizing the TPU as claimed in claim 11 for producing a molded article that are subjected to low temperatures (<0° C.).

19. The method of the TPU as claimed in claim 18, wherein the molded article is a ski shoes.

20. A method comprising utilizing a polyether polyols (b) having a number-average functionality of 1.9 to 2.1 and a number-average molecular weight of 4000 to 20 000 g/mol based on propylene oxide or propylene oxide/ethylene oxide mixtures as a low-temperature impact modifier in the production of thermoplastically processable polyurethanes.
